(19) United States
(12) Patent Application Publication
(10) Pub. No.: US 2025/0357591 A1
(43) Pub. Date: Nov. 20, 2025

(54) BATTERY PACK

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yusuke ISAJI, Osaka (JP); Hideyuki KUBOKI, Osaka (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 18/863,231

(22) PCT Filed: May 23, 2023
(86) PCT No.: PCT/JP2023/019100

§ 371 Date: Jul. 9, 2025

(30) Foreign Application Priority Data
May 25, 2022 (JP) 2022-085192

(51) Int. Cl. H01M 50/209; H01M 50/284; H01M 50/367; H01M 50/507; H01M 50/519; H01M 50/569

(52) U.S. Cl. CPC H01M 50/209; H01M 50/284; H01M 50/367; H01M 50/507; H01M 50/519; H01M 50/569

(57) ABSTRACT

A battery pack includes an assembled battery, a lower case, an upper case, and a bus bar module which includes an external connection positive terminal and an external connection negative terminal, a side wall of the upper case has an external connection connector attached thereto in advance, the external connection connector includes an external connection positive bus bar having one end fastened to the external connection positive terminal and an external connection negative bus bar having one end fastened to the external connection negative terminal, and the upper case is attached to the lower case so that the one end of the external connection positive bus bar and the external connection positive terminal will be arranged to be fastenable to each other and the one end of the external connection negative bus bar and the external connection negative terminal will be arranged to be fastenable to each other.

### TECHNICAL FIELD

The present disclosure relates to a battery pack.

### BACKGROUND ART

As a battery pack for automobiles, for example, the battery pack described in JP 2020-87913A (Patent Document 1 below) is known. This battery pack includes a case, a lid, a battery assembly, and an end assembly. The case includes a first storage chamber. The lid covers the case and includes a second storage chamber. The battery assembly is stored in a sealed space formed by the first storage chamber and the second storage chamber. The end assembly includes a panel and two or more connectors fixed to the panel. The battery assembly is electrically connected to a device outside the sealed space, such as another battery pack or a high voltage box, by the connectors. The panel is hermetically connected to the case or the lid, and is connected to the case via a bracket.

When assembling the battery pack, the battery assembly is fixed to the case, and the end assembly is attached to the case via the bracket. Subsequently, the connectors in the end assembly are passed through a window of the lid, and then the case is covered by the lid and the case and the lid are hermetically connected by a fastener and a sealing ring. The panel in the end assembly and the lid are then hermetically connected, for example a sealing ring is provided between the window and the panel, and a sealing adhesive or the like is applied.

### CITATION LIST

### Patent Documents

Patent Document 1: JP 2020-87913A

### SUMMARY OF INVENTION

### Technical Problem

In the foregoing battery pack, the bracket is covered by the lid. This requires the lid to be larger in size, making it impossible to reduce the size of the battery pack. One way of reducing the size of the battery pack may be to remove the bracket and directly fix the end assembly to the lid. However, if the end assembly is fixed to the lid and then the lid is attached to the case, it is difficult to connect the end assembly and the battery assembly. This is because the end assembly and the battery assembly are typically connected using a metal plate material such as a bus bar and additional fastening operation is needed in order to connect them.

Even if an opening for fastening operation is provided in the lid in addition to the window for attaching the end assembly, an assembly space is needed inside the lid in order to mount the end assembly in the lid so that the bus bar will be directed from the end assembly toward the opening. Moreover, the end assembly needs to be mounted in the lid so that one end of the bus bar can be connected to the battery assembly. Thus, various problems remain to enable fastening operation between one end of the bus bar and the battery assembly.

### Solution to Problem

A battery pack according to the present disclosure is a battery pack including: an assembled battery formed by stacking single batteries each having a positive electrode terminal and a negative electrode terminal; a lower case that is planar and has an upper surface on which the assembled battery is placed; an upper case that has a box shape opening downward and is attached to the lower case from above to store the assembled battery inside together with the lower case; and a bus bar module that is attached to an upper surface of the assembled battery and contains a plurality of internal connection bus bars that connect the positive electrode terminals and the negative electrode terminals, wherein the bus bar module includes an external connection positive terminal connected to the positive electrode terminals and an external connection negative terminal connected to the negative electrode terminals, a side wall of the upper case has an external connection connector attached thereto in advance, the external connection connector includes an external connection positive bus bar having one end that is fastened to the external connection positive terminal and an external connection negative bus bar having one end that is fastened to the external connection negative terminal, an upper wall of the upper case has an opening from which the one end of the external connection positive bus bar and the one end of the external connection negative bus bar are exposed to outside, and the upper case is attached to the lower case so that the one end of the external connection positive bus bar and the external connection positive terminal will be arranged to be fastenable to each other and the one end of the external connection negative bus bar and the external connection negative terminal will be arranged to be fastenable to each other.

### Advantageous Effects of Invention

According to the present disclosure, it is possible to reduce the size of the battery pack and improve its energy density.

### BRIEF DESCRIPTION OF DRAWINGS

FIG. 1 is a perspective view of a battery pack as seen from diagonally above and front.

FIG. 2 is a perspective view of the battery pack as seen from diagonally below and rear.

FIG. 3 is a perspective view of a lower case.

FIG. 4 is a perspective view showing a state in which an assembled battery is placed on the upper surface of the lower case.

FIG. 5 is a perspective view showing a state in which a bus bar module is attached to the upper surface of the assembled battery.

FIG. 6 is a perspective view showing a state in which an upper case to which an external connection connector is attached in advance is attached to the lower case from above.

FIG. 7 is a partially enlarged plan view of part of FIG. 6 as seen from above.

FIG. 8 is a perspective view of the upper case.

FIG. 9 is a perspective view of the upper case to which the external connection connector is attached in advance, as seen from diagonally above.

FIG. 10 is a perspective view of the upper case to which the external connection connector is attached in advance, as seen from diagonally below.

FIG. 11 is a partially enlarged plan view of part of the external connection connector in FIG. 9, as seen from above.

FIG. 12 is a partially enlarged front view of part of the external connection connector in FIG. 9, as seen from the front.

FIG. 13 is a partially enlarged rear view of part of the external connection connector in FIG. 9, as seen from the rear.

FIG. 14 is a plan view showing a state in which the bus bar module is attached to the upper surface of the assembled battery.

FIG. 15 is a plan view showing the internal structure of the bus bar module in FIG. 14.

FIG. 16 is a sectional view showing the internal structure of the battery pack.

FIG. 17 is a sectional view showing a fastening structure between a second connection portion of an external connection positive bus bar and an external connection positive terminal.

### DESCRIPTION OF EMBODIMENTS

### Description of Embodiments of the Present Disclosure

First, embodiments of the present disclosure will be listed and described.

(1) A battery pack according to the present disclosure is a battery pack including: an assembled battery formed by stacking single batteries having a positive electrode terminal and a negative electrode terminal; a lower case that is planar and has an upper surface on which the assembled battery is placed; an upper case that has a box shape opening downward and is attached to the lower case from above to store the assembled battery inside together with the lower case; and a bus bar module that is attached to an upper surface of the assembled battery and contains a plurality of internal connection bus bars that connect the positive electrode terminals and the negative electrode terminals, wherein the bus bar module includes an external connection positive terminal connected to the positive electrode terminals and an external connection negative terminal connected to the negative electrode terminals, a side wall of the upper case has an external connection connector attached thereto in advance, the external connection connector includes an external connection positive bus bar having one end that is fastened to the external connection positive terminal and an external connection negative bus bar having one end that is fastened to the external connection negative terminal, an upper wall of the upper case has an opening from which the one end of the external connection positive bus bar and the one end of the external connection negative bus bar are exposed to outside, and the upper case is attached to the lower case so that the one end of the external connection positive bus bar and the external connection positive terminal will be arranged to be fastenable to each other and the one end of the external connection negative bus bar and the external connection negative terminal will be arranged to be fastenable to each other.

In this battery pack, the external connection connector is not attached to the upper case via a bracket but fixed directly to the upper case. Therefore, the battery pack can be reduced in size by the omission of the bracket and can be improved in energy density. Moreover, the external connection connector is attached to the upper case in advance, and the upper case is attached to the lower case so that the one end of the external connection positive bus bar and the external connection positive terminal will be arranged to be fastenable to each other and the one end of the external connection negative bus bar and the external connection negative terminal will be arranged to be fastenable to each other. Hence, no assembly space is needed inside the upper case, with it being possible to further reduce the size of the battery pack.

(2) Preferably, the bus bar module includes a protector that holds the plurality of internal connection bus bars, the protector includes a positive terminal insulation wall formed around the external connection positive terminal and a negative terminal insulation wall formed around the external connection negative terminal, and with the upper case attached to the lower case, the one end of the external connection positive bus bar is fitted and stored within the positive terminal insulation wall and the one end of the external connection negative bus bar is fitted and stored within the negative terminal insulation wall.

When attaching the upper case to the lower case, the one end of the external connection positive bus bar is fitted and stored within the positive terminal insulation wall, and, as a result, the one end of the external connection positive bus bar is positioned to be fastenable to the external connection positive terminal, and the one end of the external connection negative bus bar is fitted and stored within the negative terminal insulation wall, and, as a result, the one end of the external connection negative bus bar is positioned to be fastenable to the external connection negative terminal.

(3) Preferably, the bus bar module includes a control board and a plurality of voltage detection wires that connect the plurality of internal connection bus bars and the control board.

Since voltage-related signals input to the control board by the plurality of voltage detection wires can be aggregated, the aggregated voltage-related signals can be output to the outside of the battery pack through one electric wire.

(4) Preferably, a gas flow path for discharging a gas generated inside the single batteries to outside is formed between the protector and the assembled battery.

Since the gas flow path is formed by attaching the bus bar module to the upper surface of the assembled battery, there is no need to form the gas flow path separately from the bus bar module.

### Details of Embodiments of the Present Disclosure

Specific examples of a connector according to the present disclosure will be described below, with reference to the drawings. The present disclosure is not limited to these examples, but is defined by the patent claims and intended to include all modifications within the meaning and scope equivalent to the patent claims.

### Embodiment

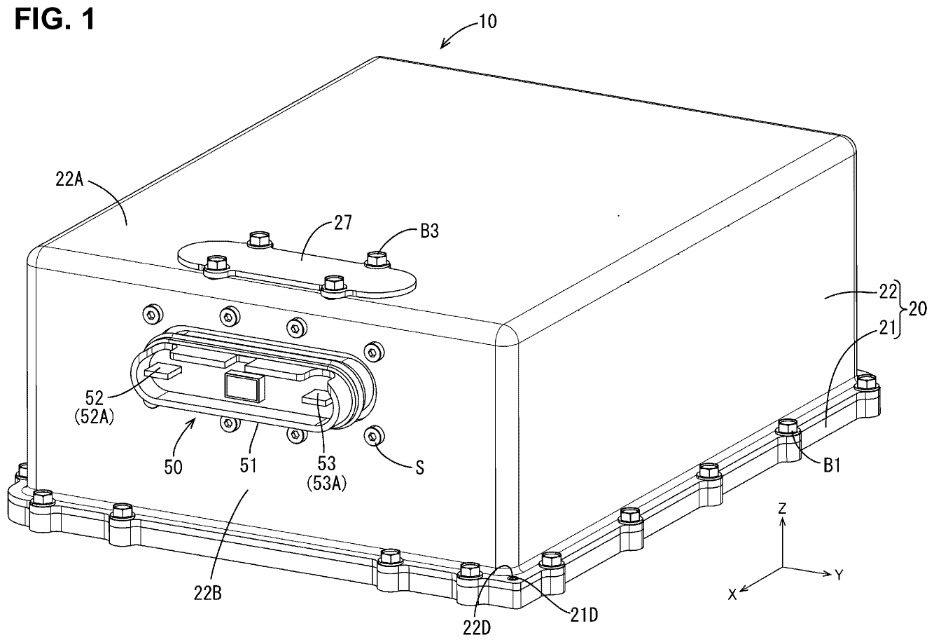

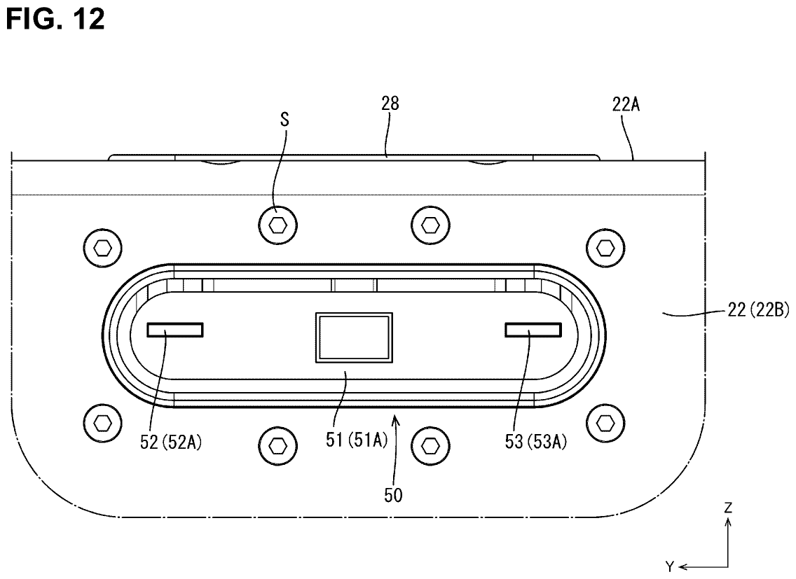

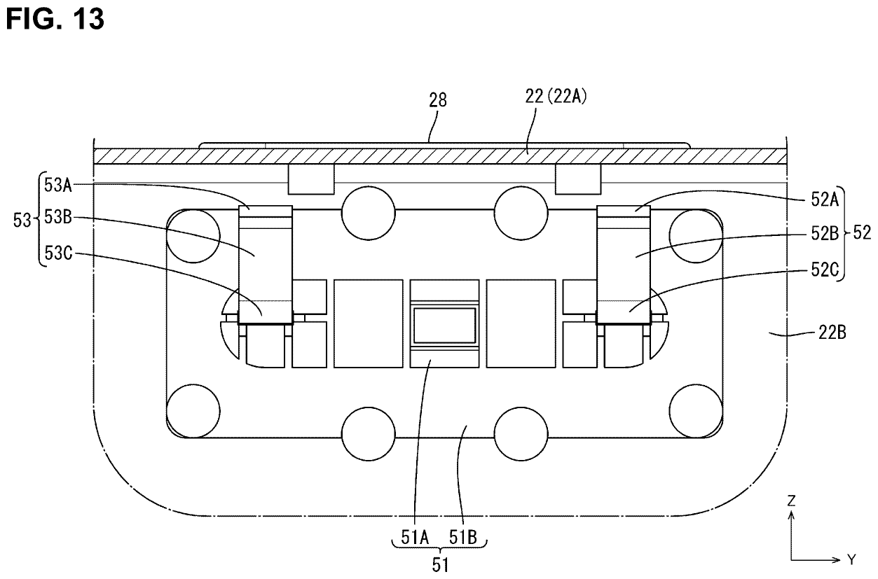

An embodiment of the present disclosure will be described with reference to FIGS. 1 to 17. In the following description, the direction indicated by arrow X is the front-rear direction, the direction indicated by arrow Y is the left right direction, and the direction indicated by arrow Z is the up-down direction. For a plurality of identical members, only some of the members may be given reference marks while omitting the reference marks of the other members.

### Battery Pack

A battery pack 10 according to this embodiment is mounted on a vehicle such as a hybrid automobile powered by an internal combustion engine such as a gasoline engine or diesel engine and a motor supplied with power from a rechargeable battery, a plug-in hybrid automobile capable of external charging, or an electric automobile.

The battery pack 10 is provided as a power source for driving such a vehicle.

### Case

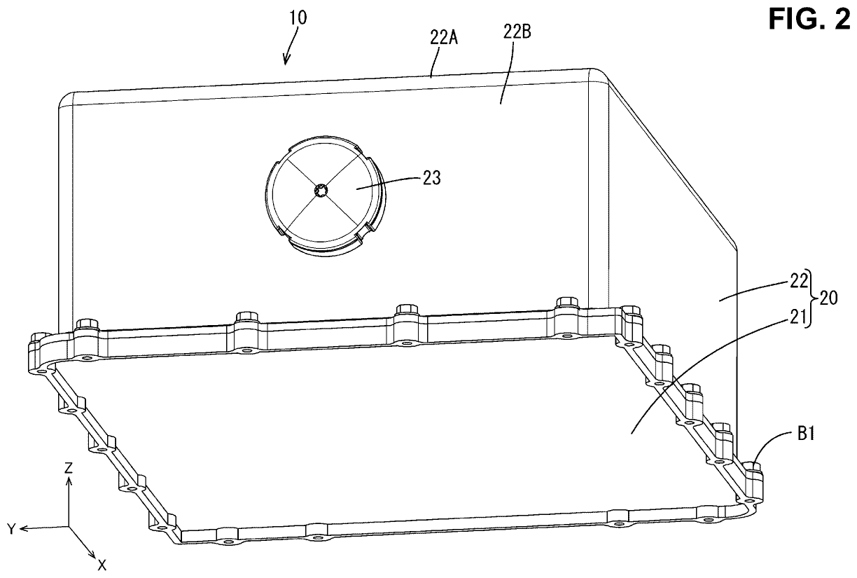

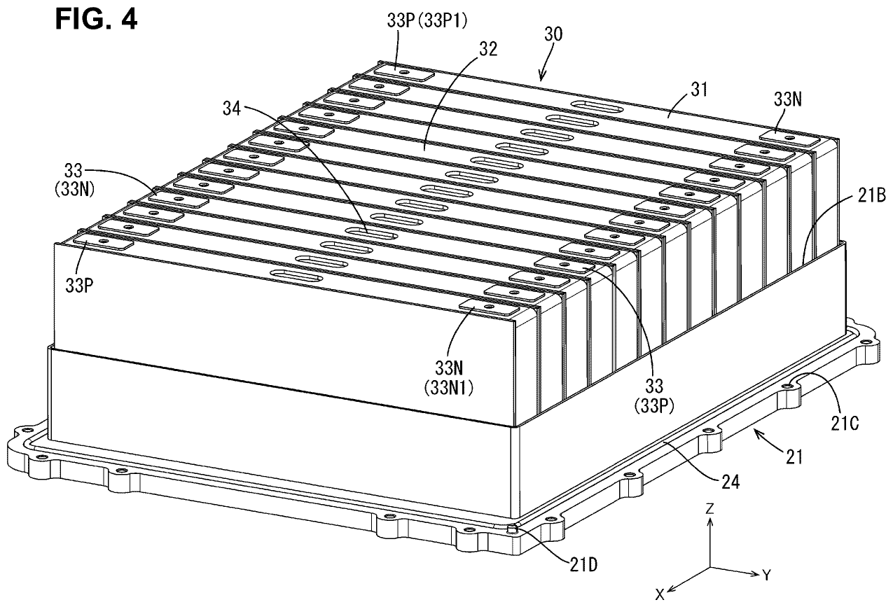

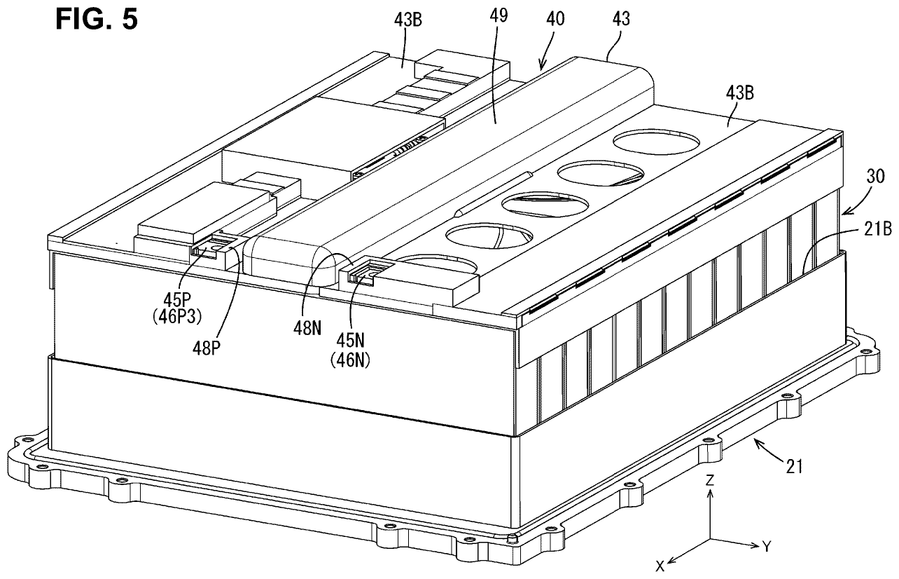

The battery pack 10 includes a case 20 composed of a planar lower case 21 and a box-shaped upper case 22 that opens downward, as shown in FIGS. 1 and 2. The case 20 has a block shape that is substantially a rectangular parallelepiped. An assembled battery 30 shown in FIG. 4 and a bus bar module 40 shown in FIG. 5 are stored inside the case 20 in a stacked state.

As shown in FIG. 2, a safety valve 23 is attached to the rear surface of the upper case 22. The safety valve 23 is connected to a gas flow path 49A (described later), and is configured to release gas in the assembled battery 30 to the outside of the case 20 when the internal pressure of the assembled battery 30 reaches a predetermined pressure.

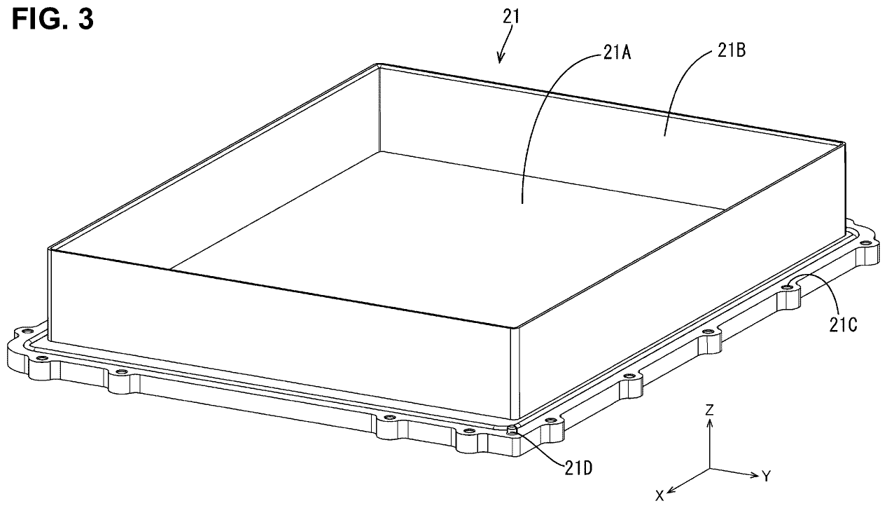

As shown in FIGS. 3 and 4, the lower case 21 has an upper surface 21A on which the assembled battery 30 is placed, a square tube portion 21B protruding upward from the upper surface 21A, a plurality of mounting holes 21C formed on the upper surface 21A around the square tube portion 21B, and a pair of positioning projections 21D.

As shown in FIG. 3, the pair of positioning projections 21D are formed at a pair of diagonal corners among the four corners of the lower case 21. A pair of positioning holes 22D are formed through the upper case 22 at positions corresponding to the pair of positioning projections 21D. As a result of the pair of positioning projections 21D being inserted into the pair of positioning holes 22D, the lower case 21 and the upper case 22 are assembled in a properly positioned state.

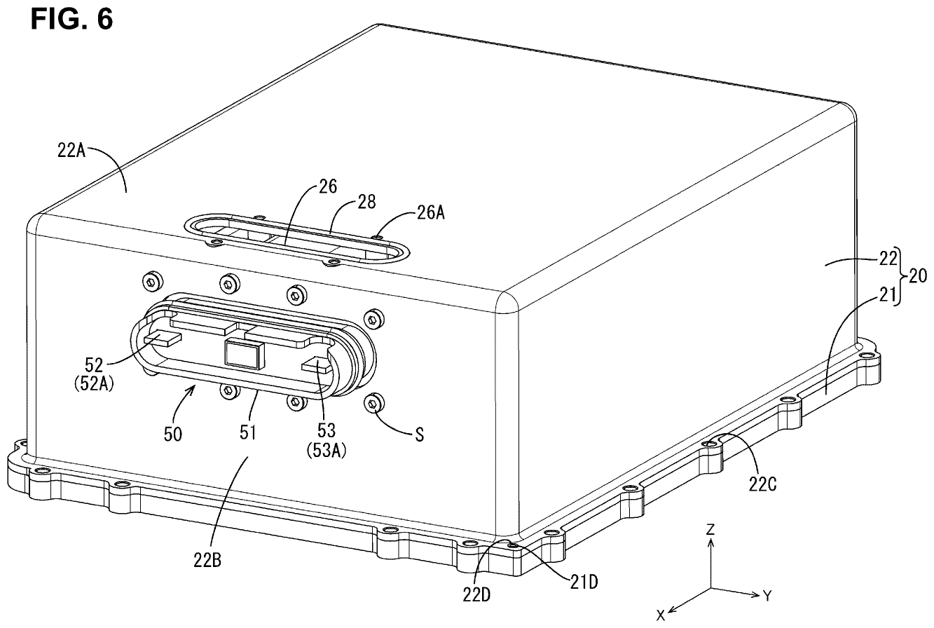

A square annular seal ring 24 is attached to the upper surface 21A of the lower case 21 between the square tube portion 21B and each mounting hole 21C. The upper case 22 has insertion holes 22C (see FIG. 6) through which mounting bolts B1 are inserted, at positions corresponding to the mounting holes 21C.

As a result of the upper case 22 being attached to the lower case 21 from above and the mounting bolts B1 being inserted through the insertion holes 22C and fastened to the mounting holes 21C, the seal ring 24 is sandwiched between the lower case 21 and the upper case 22. Thus, the lower case 21 and the upper case 22 are fixed in a sealed state.

### Assembled Battery

The battery pack 10 further includes the assembled battery 30. The assembled battery 30 is formed by stacking a plurality of single batteries (i.e. cells) 31, as shown in FIG. 4. Each single battery 31 is composed of a battery (secondary battery) such as a lithium ion battery or a nickel-metal hydride battery. The plurality of single batteries 31 are stacked in the front-rear direction (the direction indicated by arrow X in FIG. 4; hereafter also referred to as the “stacking direction of the single batteries 31”).

Each single battery 31 has a thin plate shape that is substantially a rectangular parallelepiped. The plurality of single batteries 31 are stacked so that the single batteries 31 adjacent in the stacking direction will have their side surfaces largest in area among the plurality of side surfaces forming the exterior of each single battery 31 facing each other. The plurality of single batteries 31 are stacked so that the thickness direction of each single battery 31 will be parallel to the stacking direction of the single batteries 31.

The assembled battery 30 has a rectangular parallelepiped appearance. When the assembled battery 30 is seen from above, the direction in which the long sides of the assembled battery 30 extend is parallel to the stacking direction of the single batteries 31, and the left-right direction in which the short sides of the assembled battery 30 extend (the direction indicated by arrow Y in FIG. 4) is orthogonal to the stacking direction of the single batteries 31.

The assembled battery 30 has an upper surface 32 and a plurality of electrode terminals 33. The upper surface 32 is a flat surface that forms the upper part of the assembled battery 30. The plurality of electrode terminals 33 protrude from the upper surface 32. The plurality of electrode terminals 33 are arranged in two rows in the stacking direction of the single batteries 31.

More specifically, each single battery 31 has a positive terminal 33P and a negative terminal 33N that are electrode terminals 33. In each single battery 31, the positive terminal 33P and the negative terminal 33N are apart from each other in the left-right direction. In the assembled battery 30, the positive terminals 33P and the negative terminals 33N are arranged alternately in the stacking direction of the single batteries 31. The positive terminal 33P and the negative terminal 33N adjacent in the stacking direction of the single batteries 31 are connected by an internal connection bus bar 41 (described later). The plurality of single batteries 31 are electrically connected in series.

Each single battery 31 further has a relief valve 34. The relief valve 34 is located between the positive terminal 33P and the negative terminal 33N on the upper surface 32 of the single battery 31. In the case where the pressure of the gas generated inside the single battery 31 increases, the relief valve 34 opens and relieves the pressure inside the single battery 31. Each relief valve 34 is connected to the gas flow path 49A (described later). Thus, the gas generated inside the single battery 31 is discharged to the gas flow path 49A and then discharged from the gas flow path 49A to the outside of the case 20 via the safety valve 23.

### Bus Bar Module

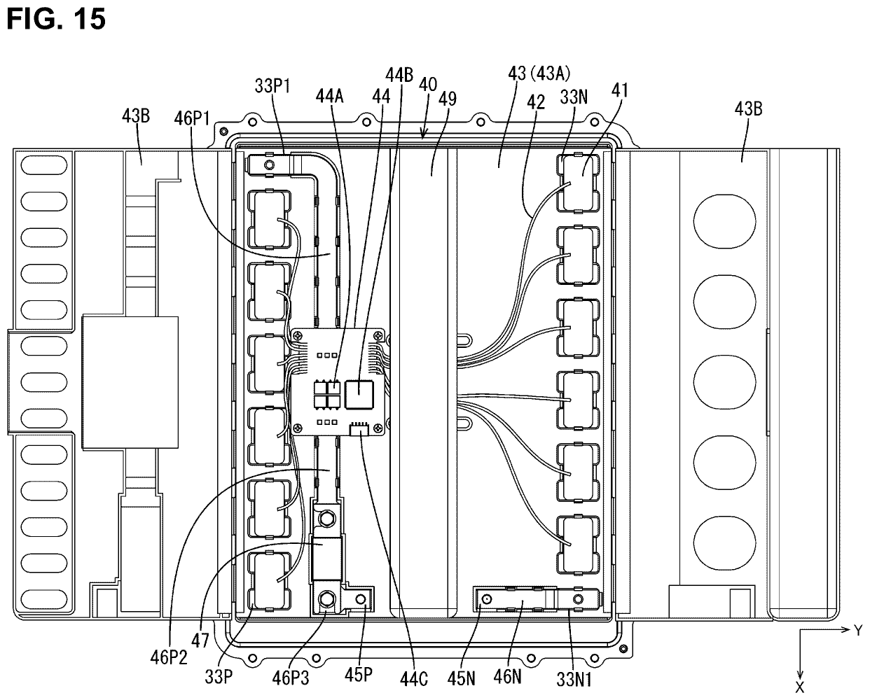

The battery pack 10 further includes the bus bar module 40. The bus bar module 40 is attached to the upper surface 32 of the assembled battery 30, as shown in FIG. 5. The bus bar module 40 has a plurality of internal connection bus bars 41, as shown in FIG. 15. The plurality of internal connection bus bars 41 are arranged in two rows in the front-rear direction indicated by arrow X. The arrangement direction of the plurality of internal connection bus bars 41 is parallel to the stacking direction of the single batteries 31.

Each internal connection bus bar 41 is connected to the positive terminal 33P and the negative terminal 33N adjacent in the stacking direction of the single batteries 31. The internal connection bus bars 41 on the left side of the drawing and the internal connection bus bars 41 on the right side of the drawing are arranged in a staggered manner in the stacking direction of the single batteries 31.

The bus bar module 40 further has a plurality of voltage detection wires 42. The voltage detection wires 42 are electric wires for detecting the state of the assembled battery 30. The voltage detection wires 42 each detect the voltage of the assembled battery 30. One end of each of the plurality of voltage detection wires 42 is connected to a corresponding one of the plurality of internal connection bus bars 41.

The bus bar module 40 further has a resin protector 43. The protector 43 has a box-shaped protector body 43A that opens upward, and a pair of covers 43B that cover the protector body 43A from above. The pair of covers 43B are connected to the left and right sides of the protector body 43A via hinges.

The protector body 43A holds the plurality of internal connection bus bars 41 and a control board 44. Each internal connection bus bar 41 is held at a position where it can be connected to the corresponding electrode terminals 33. Hence, when the bus bar module 40 is attached to the upper surface 32 of the assembled battery 30, each internal connection bus bar 41 is located at the position of the corresponding electrode terminals 33.

The other end of each of the plurality of voltage detection wires 42 is connected to the control board 44. A plurality of relays 44A, FRAM 44B, output connector 44C, etc. are installed on the control board 44. Voltage-related signals input from the voltage detection wires 42 to the control board 44 are aggregated and output from the output connector 44C to an external device through one electric wire.

The electrode terminal 33 located uppermost of the electrode terminals 33 on the left side in FIG. 15 is a positive terminal 33P, which is a total positive terminal 33P1 not connected to any internal connection bus bar 41. The electrode terminal 33 located lowermost of the electrode terminals 33 on the right side in FIG. 15 is a negative terminal 33N, which is a total negative terminal 33N1 not connected to any internal connection bus bar 41.

An external connection positive terminal 45P and an external connection negative terminal 45N are arranged at the lower end of the protector body 43A in the drawing. The external connection positive terminal 45P is located to the left of the external connection negative terminal 45N. The external connection positive terminal 45P is formed by the right end of a positive terminal third relay bus bar 46P3. The external connection negative terminal 45N is formed by the left end of a negative terminal relay bus bar 46N. The external connection positive terminal 45P is connected to one end of an external connection positive bus bar 52 (described later), and the external connection negative terminal 45N is connected to one end of an external connection negative bus bar 53 (described later).

The total positive terminal 33P1 is connected to one end of the external connection positive bus bar 52 via a positive terminal first relay bus bar 46P1, the control board 44, a positive terminal second relay bus bar 46P2, a fuse 47, and the positive terminal third relay bus bar 46P3. The total negative terminal 33N is connected to one end of the external connection negative bus bar 53 via the negative terminal relay bus bar 46N.

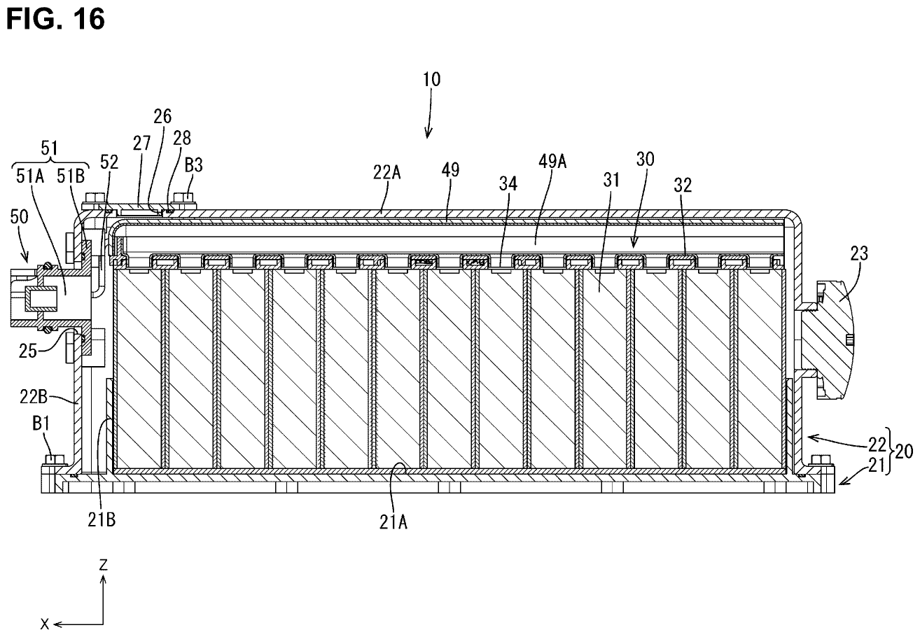

A gas flow path component 49 extending in the front-rear direction is provided in the center of the protector body 43A in the left-right direction. As shown in FIG. 16, the gas flow path 49A is formed between the gas flow path component 49 and the upper surface 32 of the assembled battery 30 to discharge the gas generated inside each single battery 31 to the outside. The relief valve 34 of each single battery 31 is connected to the gas flow path 49A. The gas flow path 49A extends in the front-rear direction, and the downstream end of the gas flow path 49A is connected to the safety valve 23.

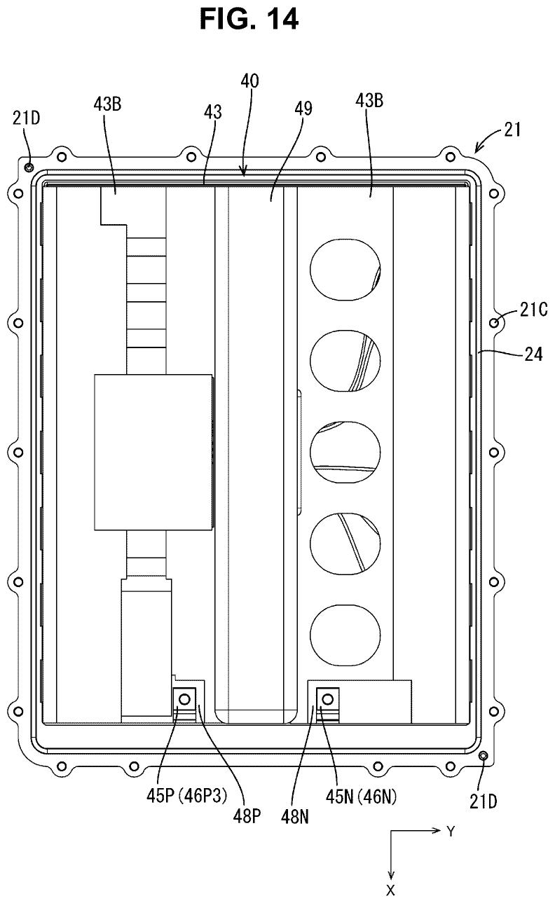

As shown in FIG. 14, a positive terminal insulation wall 48P and a negative terminal insulation wall 48N are formed on the pair of covers 43B of the protector 43. The insulation walls 48P and 48N are located on the lower end of the pair of covers 43B in the drawing. The positive terminal insulation wall 48P is formed around the external connection positive terminal 45P, and the negative terminal insulation wall 48N is formed around the external connection negative terminal 45N. The insulation walls 48P and 48N are formed by opening part of the pair of covers 43B, and each have a gate shape that opens downward in the drawing.

### External Connection Connector

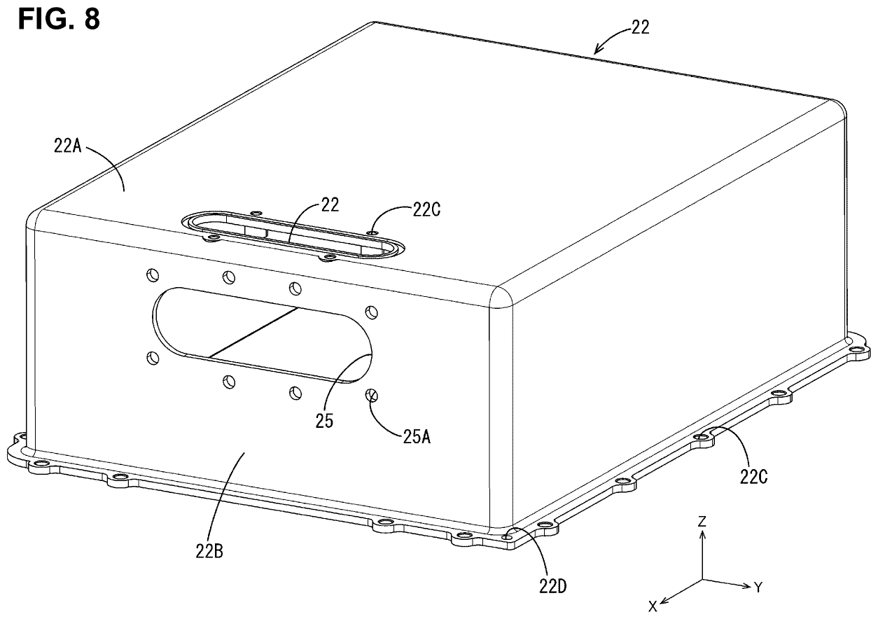

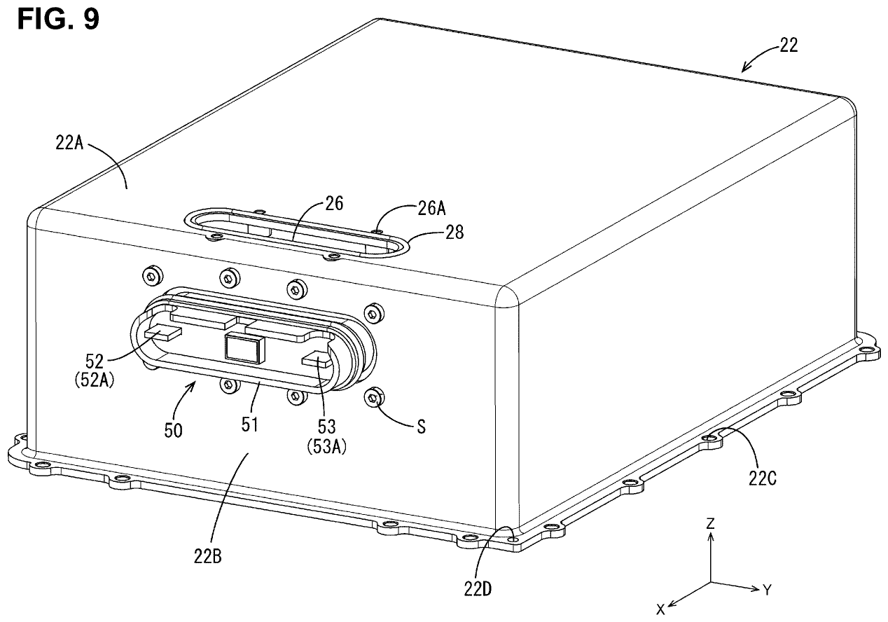

As shown in FIGS. 8 and 9, a through hole 25 through which an external connection connector 50 is inserted and placed is formed in a side wall 22B of the upper case 22. A plurality of insertion holes 25A are formed around the through hole 25 in the side wall 22B of the upper case 22. The external connection connector 50 includes a resin housing 51, the external connection positive bus bar 52, and the external connection negative bus bar 53.

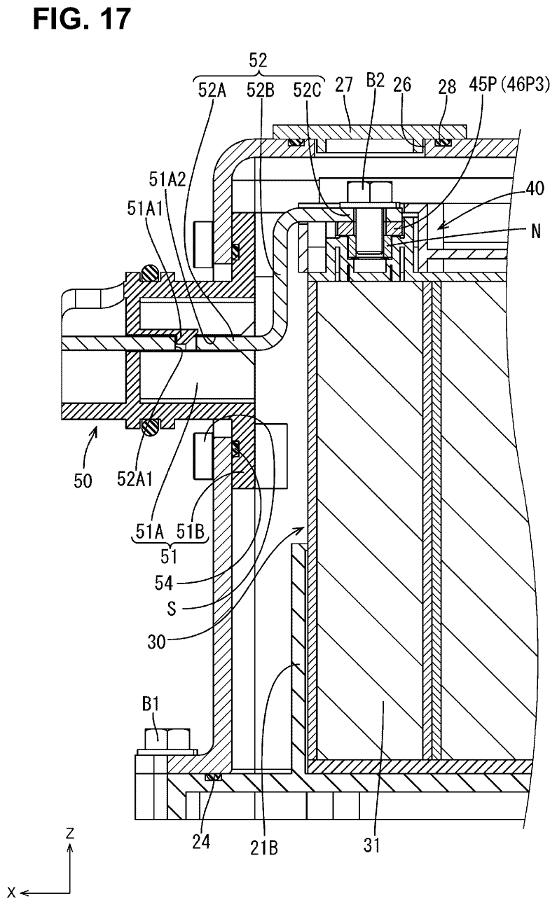

As shown in FIG. 17, the housing 51 includes a tubular housing body 51A that passes through the through hole 25 and protrudes to the outside of the upper case 22, and a flange 51B that extends from an end of the housing body 51A along the inner surface of the upper case 22. Nuts (not shown) are contained in the flange 51B. As a result of seal screws S being inserted through the insertion holes 25A from the outside of the upper case 22 and fastened to the nuts, the external connection connector 50 is fixed to the upper case 22.

An annular seal ring 54 is sandwiched between the inner surface of the upper case 22 and the flange 51B. The seal ring 54 is located around the through hole 25. This prevents water from entering the upper case 22 through the through hole 25.

Since the external connection positive bus bar 52 and the external connection negative bus bar 53 have the same shape, the external connection positive bus bar 52 will be described below as a typical example. Of the components of the external connection negative bus bar 53, the same components as those in the external connection positive bus bar 52 are given reference marks whose numeric parts are changed from 52 to 53.

The external connection positive bus bar 52 is formed by punching and bending a metal plate material with a board shape. As shown in FIG. 17, the external connection positive bus bar 52 includes a first connection portion 52A stored in the housing body 51A, a relay connection portion 52B extending upward from an end of the first connection portion 52A, and a second connection portion 52C extending from an end of the relay connection portion 52B to the opposite side to the first connection portion 52A. The part between the first connection portion 52A and the relay connection portion 52B is a bent portion, and the part between the relay connection portion 52B and the second connection portion 52C is a bent portion.

The first connection portion 52A has a locking hole 52A1. The housing body 51A has a lance 51A1 that is fitted into and locked to the locking hole 52A1. The external connection positive bus bar 52 is held in the housing 51 by the lance 51A1 being locked to the inner wall of the locking hole 52A1.

The housing body 51A has a storage hole 51A2 in which the first connection portion 52A is stored. A slight clearance is provided between the first connection portion 52A and the inner wall of the storage hole 51A2. This allows the dimensional tolerances and assembly tolerances of the components to be accommodated when the second connection portion 52C is connected to the external connection positive terminal 45P.

The distance between the relay connection portion 52B and the flange 51B is equal to or slightly greater than the plate thickness of the relay connection portion 52B. The distance between the relay connection portion 52B and the protector 43 of the bus bar module 40 is less than the plate thickness of the relay connection portion 52B. Hence, the space in which the relay connection portion 52B is stored is a considerably narrow region, and the side wall 22B of the upper case 22 is located close to the assembled battery 30 and the bus bar module 40 to thus reduce the size of the battery pack 10.

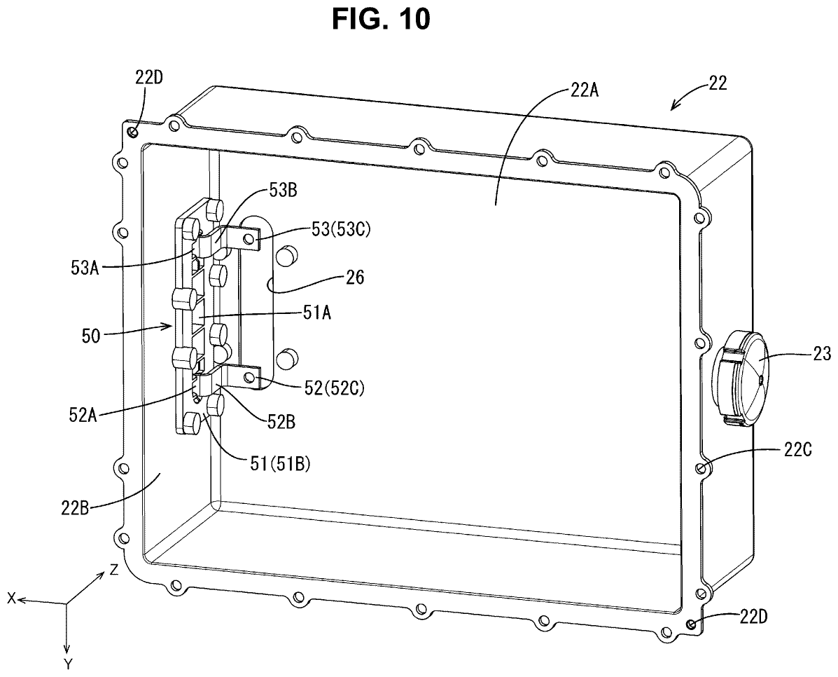

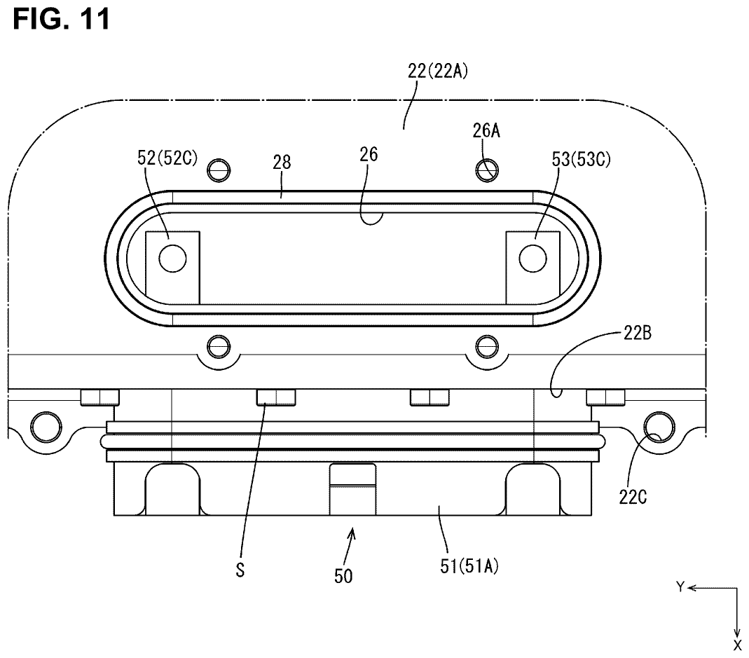

As shown in FIGS. 10 and 11, the second connection portion 52C of the external connection positive bus bar 52 and the second connection portion 53C of the external connection negative bus bar 53 are both exposed to the outside of the upper case 22 from an opening 26. The external connection positive bus bar 52 and the external connection negative bus bar 53 are both guided so as to be movable mainly in the front-rear direction by the storage hole 51A2 of the housing 51 and constrained from moving in the front-rear direction by the lance 51A1, and accordingly are held at a constant position relative to the housing 51. Therefore, the positions at which the second connection portions 52C and 53C are exposed to the outside of the upper case 22 from the opening 26 are approximately constant.

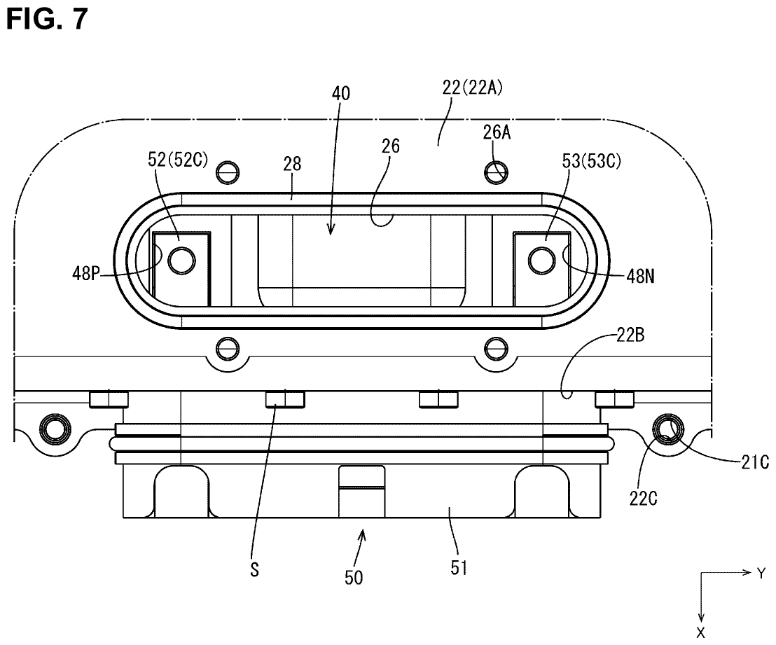

When the upper case 22 is attached to the lower case 21 in a state in which the external connection connector 50 is attached to the side wall 22B of the upper case 22 in advance, the second connection portion 52C of the external connection positive bus bar 52 and the external connection positive terminal 45P are arranged to be fastenable to each other and the second connection portion 53C of the external connection negative bus bar 53 and the external connection negative terminal 45N are arranged to be fastenable to each other as shown in FIG. 7.

The second connection portions 52C and 53C are fitted and stored within the insulation walls 48P and 48N respectively. Consequently, the bolt hole of each of the second connection portions 52C and 53C, the bolt hole of the corresponding one of the terminals 45P and 45N, and the nut N located below the terminal are coaxial with each other, as shown in FIG. 17. A connection bolt B2 can thus be fastened to the nut N from above each of the second connection portions 52C and 53C. In other words, simply by attaching the upper case 22 to the lower case 21, the second connection portions 52C and 53C and the terminals 45P and 45N are arranged so as to be fastenable to each other, respectively.

The opening 26 is closed by an auxiliary cover 27. A seal ring 28 is attached around the opening 26. The auxiliary cover 27 has insertion holes at positions corresponding to mounting holes 26A of the opening 26. As a result of closure bolts B3 being inserted through the insertion holes of the auxiliary cover 27 and fastened to the mounting holes 26A of the opening 26, the auxiliary cover 27 is fixed to the upper wall 22A of the upper case 22 and the opening 26 is closed by the auxiliary cover 27. Hence, the seal ring 28 sandwiched between the upper wall 22A of the upper case 22 and the auxiliary cover 27 prevents water from entering the case 20 through the opening 26.

### Method of Assembling Battery Pack

First, as preparation before starting the assembly of the battery pack 10, the external connection connector 50 is attached to the upper case 22 using the connection bolts B2. In addition, the internal connection bus bars 41, the control board 44, the relay bus bars 46P1, 46P2, 46P3, and 46N, and the fuse 47 are assembled inside the protector 43 and the internal connection bus bars 41 and the control board 44 are connected with the voltage detection wires 42 to assemble the bus bar module 40.

After the preparation is completed, the assembly of the battery pack 10 is started. As shown in FIG. 4, the assembled battery 30 is stored into the square tube portion 21B of the lower case 21 from above and placed on the upper surface 21A. The assembled battery 30 is positioned in the front-rear and left-right directions by the square tube portion 21B, and also is stored at a constant position in the up-down direction by being placed on the upper surface 21A.

Next, as shown in FIG. 5, the bus bar module 40 is attached to the upper surface 32 of the assembled battery 30. Since opening the pair of covers 43B reveals that each internal connection bus bar 41 is located on the corresponding electrode terminals 33, the internal connection bus bar 41 and the electrode terminals 33 are connected. The connection may be made by laser welding or bolt fastening.

After all fastening and connection operations are completed, the pair of covers 43B are closed. In this state, only the external connection positive terminal 45P of the positive terminal third relay bus bar 46P3 is exposed to the outside from the positive terminal insulation wall 48P, and only the external connection negative terminal 45N of the negative terminal relay bus bar 46N is exposed to the outside from the negative terminal insulation wall 48N. Moreover, it is made sure that the pair of second connection portions 52C and 53C are located in the opening 26 as shown in FIG. 11.

Next, the upper case 22 to which the external connection connector 50 is attached in advance is attached to the lower case 21 from above. Here, as a result of the positioning projections 21D being inserted into the respective positioning holes 22D, the upper case 22 is placed on the upper surface 21A of the lower case 21 in a state of being positioned relative to the lower case 21. Together with such positioning, the upper case 22 is attached to the lower case 21 so that the pair of second connection portions 52C and 53C will be stored respectively within the pair of insulation walls 48P and 48N as shown in FIG. 7. Thus, the upper case 22 is attached to the lower case 21 so that the second connection portion 52C of the external connection positive bus bar 52 and the external connection positive terminal 45P will be arranged to be fastenable to each other and the second connection portion 53C of the external connection negative bus bar 53 and the external connection negative terminal 45N will be arranged to be fastenable to each other.

Next, in the state shown in FIG. 6, the mounting bolts B1 are inserted through the insertion holes 22C of the upper case 22 and fastened to the mounting holes 21C of the lower case 21. Hence, the seal ring 24 is sandwiched between the lower case 21 and the upper case 22 to seal the gap between the lower case 21 and the upper case 22.

After all fastening operations are completed, the external connection positive bus bar 52 and the external connection positive terminal 45P are connected. The inside of the upper case 22 is viewed from the opening 26 to make sure that the second connection portion 52C of the external connection positive bus bar 52 is fitted and stored within the positive terminal insulation wall 48P and that the second connection portion 53C of the external connection negative bus bar 53 is fitted and stored within the negative terminal insulation wall 48N as shown in FIG. 7.

Next, the connection bolt B2 is inserted through the bolt hole of the second connection portion 52C of the external connection positive bus bar 52 and the bolt hole of the external connection positive terminal 45P and fastened to the nut N, thereby electrically connecting the external connection positive bus bar 52 and the external connection positive terminal 45P (see FIG. 17). Likewise, the connection bolt B2 is inserted through the bolt hole of the second connection portion 53C of the external connection negative bus bar 53 and the bolt hole of the external connection negative terminal 45N and fastened to the nut N, thereby electrically connecting the external connection negative bus bar 53 and the external connection negative terminal 45N.

Next, the opening 26 is closed by the auxiliary cover 27. The closure bolts B3 are inserted through the insertion holes of the auxiliary cover 27 and fastened to the mounting holes 26A arranged around the opening 26. Hence, the seal ring 28 is sandwiched between the auxiliary cover 27 and the upper wall 22A of the upper case 22 to seal the gap between the auxiliary cover 27 and the upper wall 22A of the upper case 22. After all fastening operations are completed, the battery pack 10 shown in FIG. 1 is completed.

### Functions and Effects According to Embodiment

The battery pack 10 according to the present disclosure is a battery pack 10 including: an assembled battery 30 formed by stacking single batteries 31 each having a positive electrode terminal 33 and a negative electrode terminal 33; a lower case 21 that is planar and has an upper surface 21A on which the assembled battery 30 is placed; an upper case 22 that has a box shape opening downward and is attached to the lower case 21 from above to store the assembled battery 30 inside together with the lower case 21; and a bus bar module 40 that is attached to an upper surface 32 of the assembled battery 30 and contains a plurality of internal connection bus bars 41 that connect the positive electrode terminals 33 and the negative electrode terminals 33, wherein the bus bar module 40 includes an external connection positive terminal 45P connected to the positive electrode terminals 33 and an external connection negative terminal 45N connected to the negative electrode terminals 33, a side wall 22B of the upper case 22 has an external connection connector 50 attached thereto in advance, the external connection connector 50 includes an external connection positive bus bar 52 having a second connection portion 52C that is fastened to the external connection positive terminal 45P and an external connection negative bus bar 53 having a second connection portion 53C that is fastened to the external connection negative terminal 45N, an upper wall 22A of the upper case 22 has an opening 26 from which the second connection portion 52C of the external connection positive bus bar 52 and the second connection portion 53C of the external connection negative bus bar 53 are exposed to outside, and the upper case 22 is attached to the lower case 21 so that the second connection portion 52C of the external connection positive bus bar 52 and the external connection positive terminal 45P will be arranged to be fastenable to each other and the second connection portion 53C of the external connection negative bus bar 53 and the external connection negative terminal 45N will be arranged to be fastenable to each other.

In this battery pack 10, the external connection connector 50 is not attached to the upper case 22 via a bracket but fixed directly to the upper case 22. Therefore, the battery pack 10 can be reduced in size by the omission of the bracket and can be improved in energy density. Moreover, the external connection connector 50 is attached to the upper case 22 in advance, and the upper case 22 is attached to the lower case 21 so that the second connection portion 52C of the external connection positive bus bar 52 and the external connection positive terminal 45P will be arranged to be fastenable to each other and the second connection portion 53C of the external connection negative bus bar 53 and the external connection negative terminal 45N will be arranged to be fastenable to each other. Hence, no assembly space is needed inside the upper case 22, with it being possible to further reduce the size of the battery pack 10.

Preferably, the bus bar module 40 includes a protector 43 that holds the plurality of internal connection bus bars 41, the protector 43 includes a positive terminal insulation wall 48P formed around the external connection positive terminal 45P and a negative terminal insulation wall 48N formed around the external connection negative terminal 45N, and with the upper case 22 attached to the lower case 21, the second connection portion 52C of the external connection positive bus bar 52 is fitted and stored within the positive terminal insulation wall 48P and the second connection portion 53C of the external connection negative bus bar 53 is fitted and stored within the negative terminal insulation wall 48N.

When attaching the upper case 22 to the lower case 21, the second connection portion 52C of the external connection positive bus bar 52 is fitted and stored within the positive terminal insulation wall 48P and as a result is positioned to be fastenable to the external connection positive terminal 45P, and the second connection portion 53C of the external connection negative bus bar 53 is fitted and stored within the negative terminal insulation wall 48N and as a result is positioned to be fastenable to the external connection negative terminal 45N.

Preferably, the bus bar module 40 includes a control board 44 and a plurality of voltage detection wires 42 that connect the plurality of internal connection bus bars 41 and the control board 44.

Since voltage-related signals input to the control board 44 by the plurality of voltage detection wires 42 can be aggregated, the aggregated voltage-related signals can be output to the outside of the battery pack 10 through one electric wire.

Preferably, a gas flow path 49A for discharging a gas generated inside the single batteries 31 to outside is formed between the protector 43 and the assembled battery 30.

Since the gas flow path 49A is formed by attaching the bus bar module 40 to the upper surface 32 of the assembled battery 30, there is no need to form the gas flow path 49A separately from the bus bar module 40.

### Other Embodiments

(1) Although the foregoing embodiment describes an example in which the bus bar module 40 includes the protector 43, a bus bar module without a protector may be used.

(2) Although the foregoing embodiment describes an example in which the voltage detection wires 42 are formed by electric wires, the voltage detection wires may be formed by a flexible printed wiring board.

(3) Although the foregoing embodiment describes an example in which the gas flow path 49A is formed between the protector 43 and the assembled battery 30, the gas flow path may be formed by a member other than the protector.

### LIST OF REFERENCE NUMERALS

10 Battery Pack
20 Case
21 Lower Case
21A Upper Surface
21B Square Tube Portion
21C Mounting Hole
21D Positioning Projection
22 Upper Case
22A Upper Wall
22B Side Wall
22C Insertion Hole
22D Positioning Hole
23 Safety Valve
24 Seal Ring
25 Through Hole
25A Insertion Hole
26 Opening
26A Mounting Hole
27 Auxiliary Cover
28 Seal Ring
30 Assembled Battery
31 Single Battery
32 Upper Surface
33 Electrode Terminal
33P Positive Terminal
33P1 Total Positive Terminal
33N Negative Terminal
33N1 Total Negative Terminal
34 Relief Valve
40 Bus Bar Module
41 Internal Connection Bus Bar
42 Voltage Detection Wire
43 Protector
43A Protector Body
43B Cover
44 Control Board
44A Relay
44B FRAM
44C Output Connector
45P External Connection Positive Terminal
45N External Connection Negative Terminal
46P1 Positive Terminal First Relay Bus Bar
46P2 Positive Terminal Second Relay Bus Bar
46P3 Positive terminal Third Relay Bus Bar
46N Negative Terminal Relay Bus Bar
47 Fuse
48P Positive Terminal Insulation Wall
48N Negative Terminal Insulation Wall
49 Gas Flow Path Component
49A Gas Flow Path
50 External Connection Connector
51 Housing
51A Housing Body
51A1 Lance
51A2 Storage Hole
51B Flange
52 External Connection Positive Bus Bar
52A First Connection Portion
52A1 Locking Hole
52B Relay Connection Portion
52C Second Connection Portion (One End)
53 External Connection Negative Bus Bar
53A First Connection Portion
53B Relay Connection Portion
53C Second Connection Portion (One End)
54 Seal Ring
B1 Mounting Bolt
B2 Connection Bolt
B3 Closure Bolt
N Nut
S Seal Screw

1. A battery pack comprising:
an assembled battery formed by stacking single batteries each having a positive electrode terminal and a negative electrode terminal;
a lower case that is planar and has an upper surface on which the assembled battery is placed;
an upper case that has a box shape opening downward and is attached to the lower case from above to store the assembled battery inside together with the lower case; and
a bus bar module that is attached to an upper surface of the assembled battery and contains a plurality of internal connection bus bars that connect the positive electrode terminals and the negative electrode terminals,
wherein the bus bar module includes an external connection positive terminal connected to the positive electrode terminals and an external connection negative terminal connected to the negative electrode terminals,
an external connection connector is attached in advance to a side wall of the upper case,
the external connection connector includes an external connection positive bus bar having one end that is fastened to the external connection positive terminal and an external connection negative bus bar having one end that is fastened to the external connection negative terminal,
an upper wall of the upper case has an opening from which the one end of the external connection positive bus bar and the one end of the external connection negative bus bar are exposed to outside, and
the upper case is attached to the lower case so that the one end of the external connection positive bus bar and the external connection positive terminal are arranged to be fastenable to each other and the one end of the external connection negative bus bar and the external connection negative terminal are arranged to be fastenable to each other.

2. The battery pack according to claim 1, wherein the bus bar module includes a protector that holds the plurality of internal connection bus bars,
the protector includes a positive terminal insulation wall formed around the external connection positive terminal and a negative terminal insulation wall formed around the external connection negative terminal, and
with the upper case attached to the lower case, the one end of the external connection positive bus bar is fitted and stored within the positive terminal insulation wall and the one end of the external connection negative bus bar is fitted and stored within the negative terminal insulation wall.

3. The battery pack according to claim 1, wherein the bus bar module includes a control board, and a plurality of voltage detection wires that connect the plurality of internal connection bus bars and the control board.

4. The battery pack according to claim 2, wherein a gas flow path for discharging a gas generated inside the single batteries to outside is formed between the protector and the assembled battery.
